(19) United States
(12) Patent Application Publication
(10) Pub. No.: US 2006/0275584 A1
(43) Pub. Date: Dec. 7, 2006

(54) Decorative paper

(75) Inventors: Hideaki Mori, Tokyo (JP); Kaori Imamichi, Tokyo (JP)

Correspondence Address: STAAS & HALSEY LLP, SUITE 700, 1201 NEW YORK AVENUE, N.W., WASHINGTON, DC, 20005, US

(73) Assignee: TOPPAN COSMO, INC., Tokyo (JP)

(21) Appl. No.: 11/444,326

(22) Filed: Jun. 1, 2006

(30) Foreign Application Priority Data
Jun. 2, 2005 (JP) 2005-162725
May 10, 2006 (JP) 2006-130910

(51) Int. Cl. B32B 3/00

(52) U.S. Cl. 428/156; 428/201

(57) ABSTRACT

A decorative paper has a decorative paper base material, a sealer layer formed on the decorative paper base material and provided by an aqueous adhesive, a pictorial pattern layer formed farther from the decorative paper base material than the sealer layer and provided by an aqueous ink, and a surface protective layer as an uppermost layer. The surface protective layer has a matrix resin formed by curing of an ionizing radiation-curing monomer and an antifouling agent including a silicone oil contained in the matrix resin.

### CROSS-REFERENCE TO RELATED APPLICATIONS

This application is based upon and claims the benefit of priority from prior Japanese Patent Applications No. 2005-162725, filed Jun. 2, 2005; and No. 2006-130910, filed May 10, 2006, the entire contents of both of which are incorporated herein by reference.

### BACKGROUND OF THE INVENTION

1. Field of the Invention

The present invention relates to decorative paper, and more specifically, to flat or three-dimensional pattern decorative paper used for, for example, ready-to-assemble furniture of knockdown system, and general interior materials.

2. Description of the Related Art

Conventionally, decorative paper used for, for example, ready-to-assemble furniture of knockdown system, house building materials and furniture is provided with a surface protective layer (top coat layer) for imparting wear resistance. A conventional surface protective layer is formed from an organic solvent-based printing ink or paint. However, because of problems such as releasing of an organic solvent from a printing or painting site into the atmosphere, or a sick house syndrome in a house room, aqueous inks have come to be used (see, Japanese Patent No. 3269538).

If the organic solvent-based ink/paint is replaced by an aqueous ink/paint, the amount of volatile organic compounds (VOC) decreases, but a large amount of calorie (latent heat of vaporization) is required for evaporating water in the aqueous ink/paint. For example, the latent heat of vaporization of ethyl acetate is 369 J/g, the latent heat of vaporization of toluene is 363 J/g, the latent heat of vaporization of ethanol is 839 J/g and the latent heat of vaporization of isopropyl alcohol is 667 J/g, while the latent heat of vaporization of water is 2257 J/g, indicating that water needs about several times of energy amount for vaporization, as compared with organic solvents (The Society of Synthetic Organic Chemistry, Japan, New edition Solvent Pocket Book, vol. 1, first print, Ohmsha, Ltd., Jun. 10, 1994). Resultantly, it acts counter to Kyoto Protocol to the United Nations Framework Convention on Climate Change (internet <URL.http:www.env.go.jp/earth/ondanka/mechanism/gaiyo.k.pdf> [searched on Feb. 5, 2005] relating to United Nations Framework Convention on Climate Change, Kyoto Protocol) entered into force on Feb. 16, 2005 according to which a carbon dioxide gas should be reduced for preventing global warming.

Then, a surface protective layer has been formed from an ionizing radiation-curing resin which can be cured without using a large amount of energy (see, e.g., Jpn. Pat. Appln. KOKAI Publication No. 2000-238196, and Japanese Patent No. 3162865). However, in decorative paper disclosed in Jpn. Pat. Appln. KOKAI Publication No. 2000-238196 and Japanese Patent No. 3162865, a pictorial pattern layer is also formed from an oily ink. In these patent literatures, before forming the ionizing radiation-curing resin, there is formed, on the pictorial pattern layer, a sealer layer (Jpn. Pat. Appln. KOKAI Publication No. 2000-238196) containing, as a binder, a blended resin of an acrylic resin or butyral resin and a urethane resin, or an overcoat paint layer (Japanese Patent No. 3162865) containing a polyol compound, an isocyanate compound, and a monomer and/or prepolymer having a radical-polymerizable unsaturated group, in order to prevent penetration of the ionizing radiation-curing resin into a base material of decorative paper. These sealer layer and overcoat layer are oil-based and thus exhibit excellent adhesion with an oily pictorial pattern layer. However, sufficient adhesion is not obtained when a pictorial pattern layer is formed from an aqueous ink.

Japanese Patent No. 3248425 discloses decorative paper in which a first protective layer constituted by an active energy ray-curing aqueous resin composition containing, as a main component, an aqueous emulsion resin so prepared as to exhibit no stickiness after heat drying is provided on a decorative paper base material carrying a pictorial pattern formed using an aqueous ink, and then, a second protective layer constituted by an active energy ray-curing aqueous resin composition containing no aqueous emulsion resin is provide on the first protective layer. In the active energy ray-curing aqueous resin composition, one component thereof is constituted by an ultraviolet or electron beam-curing polymer, oligomer or monomer, and at least one component contains a specified bi- or more-functional urethane(meth)acrylate or urethane methacrylate. However, when the second protective layer is constituted of an active energy ray-curing type aqueous resin composition containing no aqueous emulsion resin, adhesion with the first protective layer lowers.

Acrylic monomers are also known of which properties after curing by irradiation with an electron beam can be controlled easily (see, Japanese Patent No. 3385868, and Jpn. Pat. Appln. KOKAI Publication No. 2004-314615). However, these monomers are non-hydrophilic, and thus show poor adhesion with an aqueous resin.

Additionally, decorative paper is required that its surface is excellent in stain resistance, and the stain resistance is maintained for a relatively long period of time. However, no conventional decorative paper has such sustained surface stain resistance.

### BRIEF SUMMARY OF THE INVENTION

Therefore, an object of the present invention is to provide decorative paper having various layers, such as pictorial pattern layer and sealer layer, other than a surface protective layer, which are formed from an aqueous composition, and exhibiting excellent adhesion between the layers and sustained surface stain resistance.

In order to achieve the above object, according to an aspect of the present invention, there is provided a decorative paper comprising a decorative paper base material, a sealer layer formed on the decorative paper base material and provided by an aqueous adhesive, a pictorial pattern layer formed farther from the decorative paper base material than the sealer layer and provided by an aqueous ink, and a surface protective layer as an uppermost layer, wherein the surface protective layer comprises a matrix resin formed by curing of an ionizing radiation-curing monomer and an antifouling agent comprising a silicone oil contained in the matrix resin.

The decorative paper of the present invention can comprise a primer layer provided by an aqueous adhesive including a binder resin containing a (meth)acrylic resin as a main component, between the pictorial pattern layer and the surface protective layer.

In the decorative paper of the present invention, a liquid-repellent layer exposing the pictorial pattern layer patternwise may be provided on the pictorial pattern layer, and a surface protective layer may be formed selectively on the patternwise exposed portions of the pictorial pattern layer.

Further, the surface of the surface protective layer may be embossed.

It is more preferable that the ionizing radiation-curing monomer has no hydrophilicity.

It is more preferable that the sealer layer contains a curing agent.

### BRIEF DESCRIPTION OF THE SEVERAL VIEWS OF THE DRAWING

FIG. 1 is a schematic sectional view of decorative paper according to one embodiment of the present invention;

FIG. 2 is a schematic sectional view of decorative paper according to another embodiment of the present invention;

FIG. 3 is a schematic sectional view of decorative paper according to still another embodiment of the present invention;

FIG. 4 is a schematic sectional view of decorative paper according to still another embodiment of the present invention;

FIG. 5 is a schematic sectional view of decorative paper according to still another embodiment of the present invention; and

FIG. 6 is a schematic sectional view of decorative paper according to still another embodiment of the present invention.

### DETAILED DESCRIPTION OF THE INVENTION

Decorative paper according to the present invention comprises a decorative paper base material, a sealer layer formed on the decorative paper base material and provided by an aqueous adhesive, a pictorial pattern layer formed farther from the decorative paper base material than the sealer layer and provided by an aqueous ink, and a surface protective layer as an uppermost layer. The surface protective layer includes a matrix resin formed by curing of an ionizing radiation-curing monomer and an antifouling agent comprising a silicone oil contained in the matrix resin.

In the present invention, a decorative paper base material usually used for the decorative paper can be used without particular restriction. As such a decorative paper base material, thin paper, inter-paper reinforcement paper, and impregnated paper, for example, can be used. More specifically, thin paper such as bleached or non-bleached thin paper and inter-paper reinforcement paper, having a basis weight of 20 to 60 g/m², and impregnated paper having a basis weight of 60 to 250 g/m² can be suitably used.

The sealer layer formed on the decorative paper base material is provided by an aqueous adhesive containing an aqueous binder resin. The aqueous adhesive contains a binder resin in the form of aqueous solution or aqueous emulsion. Examples of the binder resin include resins such as (meth)acrylic resins, urethane resins, casein, epoxy resins, alkyd resins, amino acid-based resins, polyester resins, polyvinyl chloride resins, and cellulose derivatives.

These binder resins may have a double bond or have no double bond.

The binder resin contained in the aqueous adhesive is not necessarily composed of a single resin. That is, to a certain binder resin having a double bond, one or more other binder resins having a double bond or resins having no double bond may be mixed. In this case, the content of a double bond is preferably in a range of 1.0 to 150 mg KOH/g resin on the average.

Further, when the aqueous adhesive contains one or more monomers having an ethylenically unsaturated double bond which is radical-polymerized to cure by an energy ray such as ultraviolet ray and electron beam in an amount such that the content of a double bond in the binder resin becomes 1.0 to 150 mg KOH/g on the average in the binder resin, adhesion, and particularly, stain resistance can be improved. This further improvement in the adhesion is caused by the reaction of the monomers contained in the aqueous adhesive with the ionizing radiation-curing monomer constituting the surface protective layer.

Mixing of these two or more resins is effective for mutual complementarity of properties of the resins. For example, an addition of a resin which has no double bond, but is excellent in adhesion and is inexpensive to a resin which has a large amount of double bonds and is expensive can provide an aqueous adhesive composition which is excellent in adhesion and satisfactory in cost, as a whole.

When the aqueous binder resin has an acid group, a curing agent can be added to the aqueous adhesive. In this case, a curing agent having a functional group that has reactivity with the acid group contained in the aqueous binder resin is used. Such a curing agent may have, for example, an epoxy group, oxazoline group, aziridinyl group, carbodiimide group, silanol group, alkoxylyl group, amino group, hydroxyl group, or mercapto group as the functional group. One or more of these functional groups can be present in one molecule of a curing agent. The aqueous adhesive containing the curing agent can be cured by heat drying after application.

The amount of the functional group in the curing agent is preferably 0.01 to 0.50-fold equivalent based on the amount of the acid group in the aqueous binder resin. When the amount of the functional group is less than 0.01 equivalent, the density of cross-linking of the acid group in the aqueous binder resin with the functional group in a curing agent becomes small, and the stain resistance may deteriorate in some cases. When the amount of a functional group is over 0.50-fold equivalent, inter-molecular cross-linking of the aqueous binder resin becomes excess, and the sealer layer becomes rigid. Therefore, adhesion with an adjacent layer deteriorates, and in an extreme case, there occurs a tendency that an effect of alleviating the strain of the surface protective layer by the aqueous adhesive layer is deficient, and adhesion with the surface protective layer also deteriorates. Further, the poor adhesion between the layers leads to deterioration of the stain resistance.

The skeleton of the curing agent is not particularly limited. Examples thereof include skeletons of relatively low molecular weight such as pentaerythritol, trimethylolpropane, sorbitol, glycerol, resorcinol, bisphenol, ethylene glycol, and polyethylene glycol.

The curing agent is various in its kind, and thus, the suitable molecular weight thereof cannot be determined generally. However, the molecular weight of less than about 500 leaves the resulting decorative paper sticky, and sheets of decorative paper mutually adhere in some cases, though depending on its addition amount. On the other hand, when the molecular weight exceeds 1000, the amount of the functional group in the curing agent to the acid group in the resin becomes small and sufficient stain resistance is not obtained in some cases, and the viscosity of an aqueous adhesive composition increases, leading to the same problems as in the case of small molecular weight in some cases. Therefore, it is preferable that the curing agent has a molecular weight of 500 to 1000.

The application amount of the sealer layer is preferably 0.5 to 4 g/m² after drying.

The pictorial pattern layer formed farther from a decorative paper base material than the sealer layer can be formed over the decorative paper base material by applying an aqueous picture ink and drying the same. The aqueous picture ink is not particularly limited as far as it contains an aqueous binder and a colorant (e.g., pigment). The aqueous picture ink preferably contains a resin such as a (meth)acrylic resin, casein, a urethane resin, an epoxy resin, an alkyd resin, an amino acid resin, a polyester resin, a polyvinyl chloride resin, a polyethylene glycol or a cellulose derivative in the form of aqueous solution or aqueous emulsion, as the aqueous binder resin. These binder resins have a property that it become sparingly soluble in water by passing through a drying process after printed as the aqueous pictorial pattern layer. When the binder resin is a water-soluble resin (e.g., a resin having a carboxylic acid group or an amino group), its carboxylic acid group can be neutralized with an amine or the amino group can be neutralized with an acid before use. As the binder resin, (meth)acrylic resins or urethane resins having relatively good properties as a building material are preferable. These aqueous binder resins may have or may not have an acid group.

The surface protective layer constituting the uppermost layer in the decorative paper of the present invention is formed from an ionizing radiation-curing monomer and an antifouling agent comprising a silicone oil. The ionizing radiation refers to a radiation exerting an ionizing action on a substance, and includes X-ray, γ-ray, β-ray (electron beam) and shorter wavelength ultraviolet ray.

The ionizing radiation-curing monomer in the present invention is composed only of monomers. That is, the present monomer does not include an oligomer (di- or more-multimer having a molecular weight of less than 10000) and a polymer (polymers having a molecular weight of 10000 or more) as a resin forming component.

When the surface protective layer is irradiated with an ionizing radiation, the ionizing radiation-curing monomer is cured (cross-linked) to form a matrix resin, and the antifouling agent is incorporated into the matrix resin. The monomer contained in the ionizing radiation-curing monomer composition penetrates into underlying layers (e.g., pictorial pattern layer, sealer layer, primer layer described later), and cures also in the underlying layers by irradiation with an ionizing radiation to significantly improve interlaminar adhesion strength (anchor effect). Oligomers and polymers have in general high viscosity, resulting in insufficient smoothness and poor anchor effect after application.

As the ionizing radiation-curing monomer, compounds having an ethylenically unsaturated double bond can be used, including mono-functional monomers, bi-functional monomers and tri- of more-functional monomers. Usually, the monomer is a non-hydrophilic monomer having no hydrophilicity, and has none of, for example, —CHO group, —OH group and —COOH group.

Specifically, examples of the mono-functional monomer having an ethylenically unsaturated double bond include 2-(2-ethoxyethoxy)ethyl(meth)acrylate, stearyl(meth)acrylate, tetrahydrofurfuryl(meth)acrylate, lauryl(meth)acrylate, 2-phenoxyethyl(meth)acrylate, isodecyl(meth)acrylate, isooctyl(meth)acrylate, tridecyl(meth)acrylate, caprolactone(meth)acrylate, ethoxylated nonylphenol(meth)acrylate, propoxylated nonylphenol(meth)acrylate, phenoxyethyl(meth)acrylate, phenoxydiethylene(meth)acrylate, ethylene oxide-modified nonylphenyl(meth)acrylate, methoxytriethylene glycol(meth)acrylate, ethylene oxide 2-ethylhexyl(meth)acrylate, and isobonyl (meth)acrylate dipropylene glycol(meth)acrylate.

Examples of the bi-functional monomer include 1,3-butanediol di(meth)acrylate, 1,4-butanediol di(meth)acrylate, polyethylene glycol di(meth)acrylate, polypropylene glycol di(meth)acrylate, neopentyl glycol di(meth)acrylate, propoxylated neopentyl glycol di(meth)acrylate, ethoxylated neopentyl glycol di(meth)acrylate, hydroxypivalic acid neopentyl glycol di(meth)acrylate, (hydrogenated) bisphenol A di(meth)acrylate, (hydrogenated) ethylene oxide-modified bisphenol A di(meth)acrylate, (hydrogenated) propylene glycol-modified bisphenol A di(meth)acrylate, 1,6-hexanediol di(meth)acrylate, 2-ethyl-2-butyl-propanediol di(meth)acrylate, and 1,9-nonanediol di(meth)acrylate.

Examples of the poly-functional monomer include tris(2-hydroxyethyl)isocyanurate tri(meth)acrylate, ethoxylated trimethylolpropane tri(meth)acrylate, propoxylated trimethylolpropane tri(meth)acrylate, propoxylated glyceryl tri(meth)acrylate, pentaerythritol tri(meth)acrylate, trimethylolpropane(meth)acrylate, ethylene oxide-modified trimethylolpropane(meth)acrylate, propylene oxide-modified trimethylolpropane(meth)acrylate, tris(acryloxyethyl)isocyanurate, pentaerythritol tetra(meth)acrylate, ditrimethylolpropane tetra(meth)acrylate, ethoxylated pentaerythritol tetra(meth)acrylate, penta(meth)acrylate ester, and dipentaerythritol hexa(meth)acrylate.

As the ionizing radiation-curing monomers, monomers such as urethane(meth)acrylate, polyester(meth)acrylate, polyether(meth)acrylate, and polyacryl(meth)acrylate are desirable since they have low viscosity, readily providing a smooth surface after application, and enhance an anchor effect on the sealer layer, the aqueous pictorial pattern layer and the like.

The antifouling agent comprising a silicone oil contained in the surface protective layer prevents deposition of stains on the surface of the surface protective layer, and allows deposited stains to be readily wiped off with various detergents or solvents. The silicone oil antifouling agent is incorporated in the matrix resin constituted of the ionizing radiation-curing monomer. Therefore, even if removed from the surface of the protective layer when stains are wiped off, the silicone oil bleeds out from the inside of the surface protective layer again onto the surface, and thus, stain resistance can be imparted constantly to the surface protective layer.

As the silicone oil, use may be made of a non-modified silicone oil, an amino-modified silicone oil, an epoxy-modified silicone oil, a carboxy-modified silicone oil, a mercapto-modified silicone oil, a carbinol-modified silicone oil, a methacryl-modified silicone oil, and a phenol-modified silicone oil. The amount of the silicone oil is preferably 0.01 to 5% by weight based on the total weight of ionizing radiation-curing monomers. When the amount of the silicone oil is less than 0.01% by weight, the addition effect is not obtained. On the other hand, when the amount exceeds 5% by weight, the silicone oil is present in a large amount on the surface of an aqueous resin underlying layer, repelling the underlying aqueous resin, resulting in poor adhesion with the surface protective layer.

The surface protective layer can contain powders such as silica gel particles, (meth)acrylic resin beads, urethane resin beads, and urea formaldehyde resin powders, in order to further improve wear resistance. Usually, these particulate additives can be used in an amount of 0.5 to 20% by weight based on the total weight of the ionizing radiation-curing monomers. These additives do not lower adhesion and stain resistance.

For improving wettability between the surface protective layer and its underlying layers (those layers formed from the aqueous resin composition such as the pictorial pattern layer, and the sealer layer) to enhance adhesion, a mixture of the ionizing radiation-curing monomer (having no hydrophilicity), the antifouling agent and a solvent having a hydroxyl group in the molecule can be coated to form a surface protective layer, and then, the surface protective layer can be irradiated with an ionizing radiation to introduce the hydroxyl group into the resultant matrix resin molecule. Thus, the resin molecule formed by curing the ionizing radiation-curing monomer comes to have hydrophilicity, and adhesion is improved. Examples of the solvent having a hydroxyl group in the molecule include water and lower alcohols such as methanol, ethanol, n-butanol, and 2-propanol. The amount of the solvent is preferably 3 to 20 parts by weight based on 100 parts by weight of the ionizing radiation-curing monomer.

In the present invention, the surface protective layer is preferably applied in an amount of usually 1 to 50 g/m², preferably 1 to 25 g/m², optimally 7 g/m² after drying, although the amount may vary depending on the specific gravity of the resulting matrix resin.

In the decorative paper of the present invention, it is preferable to provide a primer layer between the pictorial pattern layer and the surface protective layer in order to improve interlaminar adhesion. The primer layer is preferably formed from an aqueous adhesive including a binder resin containing a (meth)acrylic resin as a main component (occupying 50% by weight or more of the total weight of the binder resin) in order to prevent strain caused by shrinkage in curing of the surface protective layer. The aqueous adhesive contains the binder resin in the form of aqueous solution or aqueous emulsion. Examples of the binder resin which can be used in the aqueous adhesive together with the (meth)acrylic resin include resins such as urethane resins, casein, epoxy resins, alkyd resins, amino acid-based resins, polyester resins, polyvinyl chloride resins, and cellulose derivatives. Among them, urethane resins are preferable. Excepting these matters, the aqueous adhesive forming the primer layer is the same as the above-mentioned aqueous adhesive providing the sealer layer, and therefore, the details (presence of double bond, its content, monomer having ethylenically unsaturated double bond and amount of double bond, curing agent, and the like) are not repeated here. The application amount of the primer layer is preferably about 0.5 to 10 g/m² after drying.

In the decorative paper of the present invention, an opacifying layer can be formed directly below the pictorial pattern layer. This opacifying layer is formed from an aqueous opacifying ink containing an opacifying pigment and a binder resin. As the opacifying pigment, titanium oxide, iron oxide, carbon black and the like can be used. As the binder resin, an aqueous urethane resin, aqueous acrylic resin, casein and the like can be used. These resins are contained in the form of aqueous solution or aqueous emulsion in an aqueous opacifying ink.

In the decorative paper of the present invention, the surface protective layer can have a concavoconvex pattern such as a wood tracheary pattern. This concavoconvex pattern can be provided by embossing the surface protective layer.

Alternatively, the concavoconvex pattern of the surface protective layer can be formed by applying an aqueous liquid-repellent resin composition containing a liquid-repelling agent and an aqueous binder resin (in the form of aqueous solution or aqueous emulsion) in the form of pattern on the pictorial pattern layer (namely, applying so as to patternwise expose the pictorial pattern layer), and applying thereon a composition forming the surface protective layer, directly or via the aqueous primer layer. The aqueous primer layer and surface protective layer are repelled by the liquid repelling agent at a portion or portions where the aqueous liquid repellent resin composition is present, and remain only on that portion or portions of the pictorial pattern layer where the aqueous liquid repellent resin composition is not present. Thus, on the surface protective layer (also the primer layer if present), a portion or portions corresponding to the portion or portions where the aqueous liquid repellent resin composition is present are formed as a convex or convexes. As the aqueous liquid repellent resin composition, those containing an aqueous acrylic resin as a binder and an aqueous fluorine resin as a liquid repelling agent are particularly preferable. The aqueous liquid repellent resin composition may contain also a pigment and a curing agent, if necessary.

Further, it is also possible that the surface protective layer is matte finished on the whole surface with a grain pattern or abstract pattern, and then, a missing pattern such as trachea is printed. The tracheary pattern can be visualized by a difference in gloss.

In the decorative paper of the present invention, the surface protective layer and adhesion layers (sealer layer and primer layer) are usually transparent.

Next, the present invention will be described more specifically with reference to the drawings. Throughout the figures, the same constituent element is represented by the same reference numeral.

FIG. 1 is a schematic sectional view illustrating a structure of decorative paper according to one embodiment of the present invention. Decorative paper 10 shown in FIG. 1 has a pictorial pattern layer 12 formed on a decorative paper base material 11. On the pictorial pattern layer 12, a surface protective layer 13 formed from the ionizing radiation-curing monomer composition containing the antifouling agent is provided. A sealer layer 14 is provided between the decorative paper base material 11 and the pictorial pattern layer 12. As described above, a primer layer 15 can be provided between the pictorial pattern layer 12 and the surface protective layer 13. These adhesive layers further improve interlaminar adhesion.

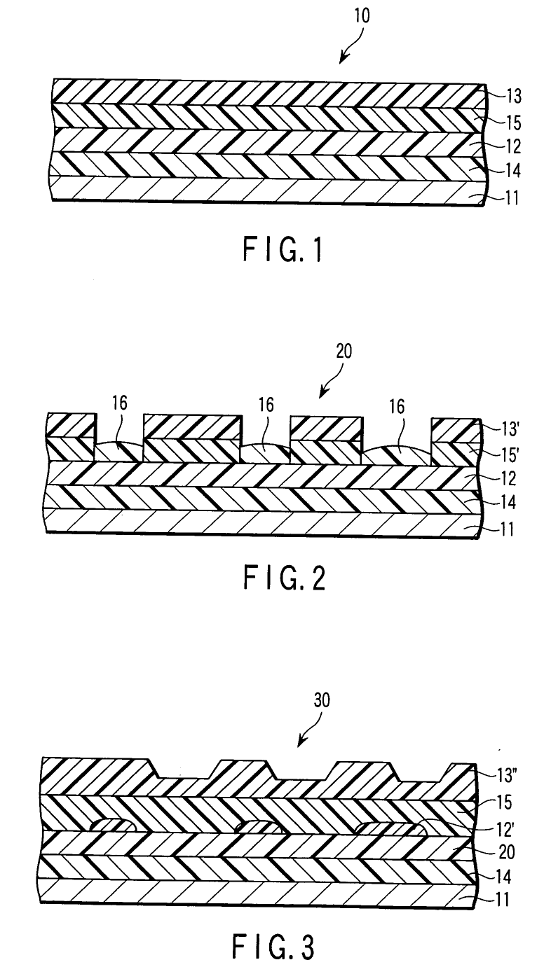

FIG. 2 is a schematic sectional view illustrating a structure of decorative paper according to another embodiment of the present invention. Decorative paper 20 shown in FIG. 2 has the same structure as the decorative paper shown in FIG. 1, except that a concavoconvex pattern is provided on the surface protective layer (and primer layer). The concavoconvex pattern is formed by providing an aqueous liquid repellent resin composition 16 in the form of pattern on a pictorial pattern layer 12, and applying thereon, if necessary, an aqueous primer composition (aqueous adhesive) and thereon an ionizing radiation-curing monomer composition. The primer composition and ionizing radiation-curing monomer composition are repelled by the aqueous liquid repellent resin composition 16, and deposit selectively as shown by reference numerals 15′ and 13′, respectively, on portions of the pictorial pattern layer 12 on which the aqueous liquid repellent resin composition is not present. Thus, the surface protective layer 13′ (and primer layer 15′) have a concave portion at a portion corresponding to the aqueous liquid repellent resin composition 16.

FIG. 3 illustrates decorative paper 30 in which a pictorial pattern layer is formed in the form of pattern (shown at 12′), a surface protective layer 13″ is embossed and an opacifying layer 20 is provided directly below the pictorial pattern layer 12′.

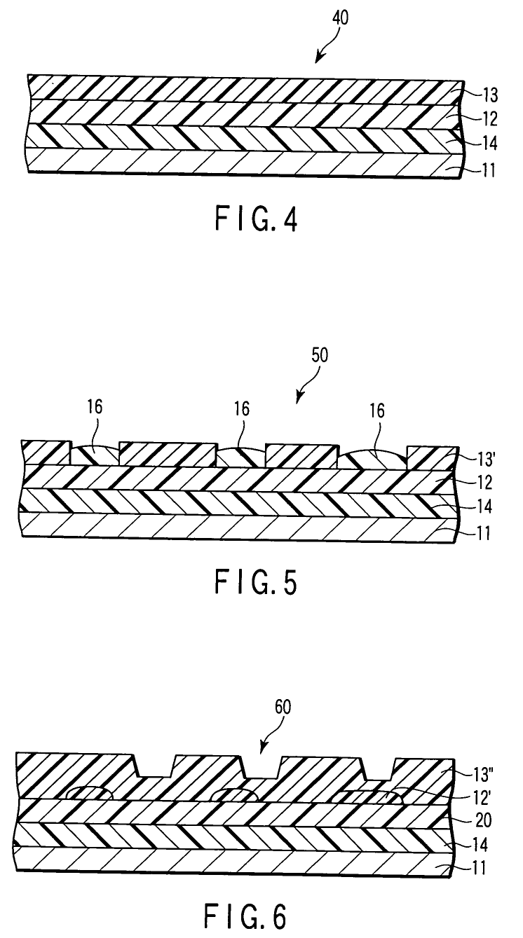

FIG. 4 illustrates decorative paper 40 having the same constitution as the decorative paper 10 shown in FIG. 1 except that no primer layer 15 is provided. Although the primer layer 15 is not provided, adhesion between the surface protective layer 13 and the pictorial pattern layer 12 is significantly high owing to the anchor effect provided by the ionizing radiation-curing monomer constituting the surface protective layer 13.

FIG. 5 illustrates decorative paper 50 having the same constitution as the decorative paper 20 shown in FIG. 2 except that no primer layer 15′ is provided. Also in this case, adhesion between the surface protective layer 13′ and the pictorial pattern layer 12 is significantly high owing to the anchor effect provided by the ionizing radiation-curing monomer constituting the surface protective layer 13′.

FIG. 6 illustrates decorative paper 60 having the same constitution as the decorative paper 30 shown in FIG. 3 except that no primer layer 15′ is provided. Also in this case, adhesion of the surface protective layer 13″ with the pictorial pattern layer 12′ and the opacifying layer 20 is significantly high owing to the anchor effect provided by the ionizing radiation-curing monomer constituting the surface protective layer 13″.

Various embodiments of the present invention have been described above, but the present invention is not limited to these embodiments. Constitutions of the layers shown in these embodiments can be combined with each other.

The present invention will be described below by way of Examples.

### EXAMPLE 1

On the surface of inter-paper reinforcement paper having a basis weight of 30 g/m² (A20C, manufactured by Tentok Paper Co., Ltd., Japan), an aqueous urethane resin-based paint having reactive groups (LW 059 Sealer, manufactured by Toyo Ink Mfg. Co., Ltd., Japan) was applied such that the application amount after drying was 1 g/m², to form a sealer layer. On this sealer layer, a wood grain pattern was gravure-printed by using an aqueous picture ink composed of 50 parts by weight of an aqueous acrylic resin binder (manufactured by Toyo Ink Mfg. Co., Ltd., Japan; solid content: 25 wt %, acid value: 150 mg KOH/g), 1 part by weight of an aqueous resin having an oxazoline ring as a curing agent (solid content: 40 wt %, functional group value: 252 mg KOH/g), an ink (PCW, manufactured by Toyo Ink Mfg. Co., Ltd., Japan; composed of each 1 part by weight of disazo-based red pigment, disazo-based yellow pigment and phthalocyanine-based indigo blue pigment) and 40 parts by weight of water. A mixture (Primer-A, manufactured by Liochem, Inc.) of an aqueous acrylic resin emulsion (solid content: 40 wt %) and an aqueous urethane resin emulsion (urethane resin emulsion having a double bond; solid content: 40 wt %) at a weight ratio of 7:3 was diluted with water and coated as an aqueous primer layer on the pictorial pattern layer such that the application amount after drying was 2 g/m². On this primer layer, a mixture (ionizing radiation-curing composition) of ionizing radiation-curing monomers (50 parts by weight of pentaerythritol tri(meth)acrylate, 50 parts by weight of ethoxylated trimethylolpropane (meth)acrylate) and 0.5 part by weight of an amino-modified silicone oil was coated in an amount of 10 g/m². Then, the coating was cured by irradiation with an electron beam in a nitrogen atmosphere to form a surface protective layer. The irradiation conditions were: a dose of 50 KGy (5 Mrad), 125 V and a line speed of 200 m/min. Thus, decorative paper 10 having a structure shown in FIG. 1 was manufactured.

### EXAMPLE 2

Decorative paper 20 having a structure shown in FIG. 2 was manufactured in the same manner as in Example 1 except that under the pictorial pattern layer in Example 1, an aqueous opacifying layer (ink manufactured by Toyo Ink Mfg. Co., Ltd.; composed of titanium oxide-based white pigment, iron oxide-based brown pigment, iron oxide-based khaki pigment and carbon black-based black pigment) was gravure-printed such that the application amount after drying was 10 g/m², and thereon, a tracheary pattern was printed by using an aqueous liquid repellent pattern layer (composed of 40 parts by weight of aqueous acrylic resin, 25 parts by weight of aqueous melamine resin, 30 parts by weight of aqueous fluorine resin emulsion and 5 parts by weight of carbon black).

### EXAMPLE 3

Decorative paper 30 having a structure shown in FIG. 3 was manufactured by imparting a concavoconvex pattern by using a metal concavoconvex roller to a surface protective layer of decorative paper manufactured by the same manner as in Example 1 except that under the aqueous pictorial pattern layer in Example 1, the aqueous opacifying layer as in Example 2 was provided. The concavoconvex roller was heated from room temperature to about 100° C. if necessary.

### EXAMPLE 4

Decorative paper 40 having a structure shown in FIG. 4 was manufactured in the same manner as in Example 1 except that the primer layer was not provided.

### EXAMPLE 5

Decorative paper 50 having a structure shown in FIG. 5 was manufactured in the same manner as in Example 2 except that the primer layer was not provided.

### EXAMPLE 6

Decorative paper 60 having a structure shown in FIG. 6 was manufactured in the same manner as in Example 3 except that the primer layer was not provided.

### EXAMPLE 7

Decorative paper having a structure shown in FIG. 1 was manufactured in the same manner as in Example 1 except that 5 parts by weight of water was added to the ionizing radiation-curing composition.

### EXAMPLE 8

Decorative paper was manufactured in the same manner as in Example 1 except that 5 parts by weight of a curing agent (LT 109 EB Hardener manufactured by Liochem, Inc.) was added to the aqueous urethane resin-based paint of the sealer layer.

### COMPARATIVE EXAMPLE 1

Decorative paper was manufactured in the same manner as in Example 1 except that an ionizing radiation-curing oligomer (100 parts by weight of diethylene glycol dimethacrylate) was used instead of the ionizing radiation-curing monomers (50 parts by weight of pentaerythritol tri(meth)acrylate, 50 parts by weight of ethoxylated trimethylolpropane(meth)acrylate).

### COMPARATIVE EXAMPLE 2

Decorative paper was manufactured in the same manner as in Example 1 except that an oily urethane resin-based paint (“EX-7” manufactured by Dai Nippon Toryo Co., Ltd.) was used instead of the aqueous urethane resin-based paint of the sealer layer.

### COMPARATIVE EXAMPLE 3

Decorative paper was manufactured in the same manner as in Example 1 except that 0.5 parts by weight of the amino-modified silicone oil was not added.

<Evaluation of Performances>

The thin decorative papers manufactured in Examples 1 to 8 and Comparative Examples 1 to 3 were each adhered to a particle board having a thickness of 5 mm with a urea-based adhesive to prepare decorative laminates, and each decorative laminate was evaluated in its performance as follows.

1. Adhesion

On the decorative paper of each decorative laminate, 25 grids of 1 mm width were made by a cutter, and a cellophane tape (Registered trademark of Nichiban Co., Ltd.) of 25 mm width was attached thereon by using BEMCOT (manufactured by Asahi Kasei Fibers Corporation) and allowed to stand for 24 hours. Then, the cellophane tape (Registered trademark of Nichiban Co., Ltd.) was pulled at an angle of 45° above the horizontal direction. When the number of peeled grid pieces was 5 or less, adhesion was evaluated as acceptable (passed).

2. Stain Resistance

(a) Acid Resistance

On each decorative laminate, absorbent cotton impregnated sufficiently with a 10% citric acid aqueous solution was placed, covered with a watch glass, and allowed to stand for 18 hours. 18 hours after, its surface was wiped with the absorbent cotton. The surface condition was observed, and compared with the non-treated surface.

(b) Alkali Resistance

Alkali resistance was evaluated in the same manner as for the acid resistance evaluation by using a 10% ammonia aqueous solution instead of the citric acid aqueous solution.

(c) Solvent Resistance

Solvent resistance was evaluated in the same manner as for the acid resistance evaluation by using a mixture of isopropyl alcohol and water at a volume ratio of 70:30 instead of the citric acid aqueous solution.

(d) Dyeing Resistance

Dyeing resistance was evaluated in the same manner as for the acid resistance evaluation by using a violet dye ink (alcohol solvent-based) instead of the citric acid aqueous solution.

Evaluation criteria are as follows.

<Adhesion>

⊚ no peeled grid piece

◯ 1 to 3 peeled grid pieces

Δ 4 to 5 peeled grid pieces

X 6 or more peeled grid pieces

<Acid Resistance, Alkali Resistance, Solvent Resistance>

Regarding swelling, peeling, softening, remarkable coloration, gloss change, respectively,

⊚ none

◯ slight

Δ somewhat

X change observed

<Dyeing Resistance>

⊚ no color remaining on the surface of decorative paper

◯ slight color remaining on the surface of decorative paper

Δ somewhat color remaining on the surface of decorative paper

X clearly visible color remaining on the surface of decorative paper

The results are shown in Table 1 below.

TABLE 1
Results of evaluation of performances of decorative laminates

| Performances | Examples | | | | | | | | Comparative Examples | | |
|---|---|---|---|---|---|---|---|---|---|---|---|
| evaluated | 1 | 2 | 3 | 4 | 5 | 6 | 7 | 8 | 1 | 2 | 3 |
| Adhesion | ⊚ | ⊚ | ◯ | Δ | ◯ | ◯ | ◯ | ⊚ | X | X | X |
| (peeled | (0) | (0) | (2) | (3) | (2) | (1) | (1) | (0) | (6) | (6) | (6) |
| number) | | | | | | | | | | | |
| Stain | | | | | | | | | | | |
| resistance: | | | | | | | | | | | |
| Acid | ◯ | ◯ | ◯ | ◯ | ◯ | ◯ | ◯ | ◯ | ◯ | ◯ | Δ |
| resistance | | | | | | | | | | | |
| Alkali | ◯ | ◯ | ◯ | ◯ | ◯ | ◯ | ◯ | ◯ | ◯ | ◯ | Δ |
| resistance | | | | | | | | | | | |
| Solvent | ◯ | ◯ | ◯ | ◯ | ◯ | ◯ | ◯ | ◯ | ◯ | ◯ | Δ |
| resistance | | | | | | | | | | | |
| Dyeing | ◯ | ◯ | ◯ | ◯ | ◯ | ◯ | ◯ | ◯ | ◯ | ◯ | X |
| resistance | | | | | | | | | | | |
| Total | Passed | Passed | Passed | Passed | Passed | Passed | Passed | Passed | Rejected | Rejected | Rejected |
| evaluation | | | | | | | | | | | |

From the results shown in Table 1, it is seen that the decorative paper of the present invention is excellent in adhesion and stain resistance.

As described above, the present invention provides decorative paper in which various layers, such as pictorial pattern layer, and sealer layer, other than a surface protective layer, are formed from an aqueous composition. The decorative paper has excellent adhesion between the layers and sustained surface stain resistance.

What is claimed is:

1. A decorative paper comprising a decorative paper base material, a sealer layer formed on the decorative paper base material and provided by an aqueous adhesive, a pictorial pattern layer formed farther from the decorative paper base material than the sealer layer and provided by an aqueous ink, and a surface protective layer as an uppermost layer, wherein the surface protective layer comprises a matrix resin formed by curing of an ionizing radiation-curing monomer and an antifouling agent comprising a silicone oil contained in the matrix resin.

2. The decorative paper according to claim 1, wherein a primer layer provided by an aqueous adhesive including a binder resin containing a (meth)acrylic resin as a main component is formed between the pictorial pattern layer and the surface protective layer.

3. The decorative paper according to claim 1, wherein a liquid repellent layer exposing the pictorial pattern layer in the form of pattern is provided on the pictorial pattern layer, and the surface protective layer is selectively formed on the patternwise exposed portion of the pictorial pattern layer.

4. The decorative paper according to claim 1, wherein the surface protective layer is embossed.

5. The decorative paper according to claim 1, wherein the monomer has no hydrophilicity.

6. The decorative paper according to claim 1, wherein a curing agent is added to the sealer layer.
